(19) United States
(12) Patent Application Publication
(10) Pub. No.: US 2010/0186480 A1
(43) Pub. Date: Jul. 29, 2010

(54) METHOD AND APPARATUS FOR DETECTING FAULTS IN ELECTRICAL APPARATUS

(75) Inventors: John Cunningham, County Tyrone (GB); Colin McIlroy, County Down (GB); Robert Watson, County Down (GB); Kenneth Richey, County Down (GB); Alan Mills, County Down (GB)

Correspondence Address: VAN DYKE, GARDNER, LINN & BURKHART, LLP, SUITE 207, 2851 CHARLEVOIX DRIVE, S.E., GRAND RAPIDS, MI, 49546, US

(73) Assignee: Kelvatek Limited, Belfast (GB)

(21) Appl. No.: 12/526,364

(22) PCT Filed: Feb. 8, 2008
(86) PCT No.: PCT/EP2008/000977

§ 371 Date: Mar. 2, 2010

(30) Foreign Application Priority Data
Feb. 8, 2007 (GB) 0702433.4

(51) Int. Cl. G01N 7/00; G01N 1/00

(52) U.S. Cl. 73/23.2; 73/863

(57) ABSTRACT

A diagnostic device for use in the detection of a fault in an electrical apparatus, especially transformers that have electrical windings immersed in electrical insulating oil with a headspace above the oil. The device comprises a housing defining a chamber with a mouth adapted to receive a pressure relief valve on the oil tank. The device creates a fluid tight seal around the pressure relief valve and operates the pressure relief valve to extract a gas sample from the headspace into the chamber. The device may include a gas analyzer for analyzing the gas sample for the presence of acetylene, which is indicative of a fault in the apparatus.

### FIELD OF THE INVENTION

The present invention relates to the detection of faults in electrical equipment, especially electrical transformers, which contain insulating oil.

### BACKGROUND TO THE INVENTION

When a fault occurs in an electrical supply or distribution system, the utility operator sends an operative crew out to fix the fault. A common point of inspection is at the electrical transformers that form part of the supply/distribution network. Often, the fuse(s) at the high voltage side of the transformer have blown and the fault can be fixed by replacing the fuse(s). In other cases, however, there may be a fault in the transformer in which case replacing the fuse(s) can be very dangerous.

Determining whether or not there is a fault with the transformer cannot normally be done by simple observation. Therefore, the crew is faced with two options; replace the transformer, or replace the fuses and re-energize the transformer to restore supply. If the transformer has not suffered any internal damage the fastest, cheapest, and correct option is to replace the fuses. However if the transformer has an internal fault it has the potential to fail catastrophically if re-energized, creating a severe risk to the crew and any surrounding customers. Electrical tests on transformers have proved inconclusive in identifying faults and so, in spite of the best efforts of the crew, there remains a significant risk of transformer failure when the fuses are replaced.

It would be desirable to mitigate the problems outlined above.

### SUMMARY OF THE INVENTION

A first aspect of the invention provides a diagnostic device for use in the detection of a fault in an electrical apparatus comprising an enclosure containing at least one electrical component immersed in electrical insulating oil, the oil partly filling the enclosure to define a headspace adjacent the oil, and wherein a pressure relief valve is provided in the enclosure to vent excess fluid pressure in the headspace, the device comprising a housing defining a first chamber, the first chamber having a mouth adapted to receive said pressure relief valve; means for creating a substantially fluid tight seal around said pressure relief valve; and means for operating the pressure relief valve to extract a gas sample from said headspace into said first chamber.

In preferred embodiments, the device includes a gas analyser for analysing said gas sample to detect the presence of one or more target gases, for example acetylene (C₂H₂). Preferably still, the device includes means for indicating a fault in said electrical application upon detection of at least one of said one or more gases.

A second aspect of the invention provides a method for detecting a fault in an electrical apparatus comprising an enclosure containing at least one electrical component immersed in electrical insulating oil, the oil partly filling the enclosure to define a headspace adjacent the oil, and wherein a pressure relief valve is provided in the enclosure to vent excess fluid pressure in the headspace, the method comprising operating the pressure relief valve to extract a gas sample from said headspace; analysing the gas sample for the presence of one or more target gases; and, upon detection of at least one of said one or more target gases, determining that there is a fault in the electrical apparatus.

A further aspect of the invention provides a method of determining if there is a fault in an electrical apparatus, especially but not exclusively an electrical transformer, containing insulating oil and having a headspace adjacent the oil, the method comprising extracting a gas sample from said headspace; analysing the gas sample for the presence of one or more target gases; and, upon detection of at least one of said one or more target gases, determining that there is a fault in the equipment. Preferably, said extraction involves extracting said gas sample from a pressure relief valve associated with said headspace. Conveniently, said analysis involves detecting the presence of acetylene (C₂H₂) in the gas sample.

A still further aspect of the invention provides a method of determining whether or not to replace at least one fuse associated with an electrical transformer, the transformer including an enclosure containing electrical windings immersed in insulating oil and including a headspace above the insulating oil, the method comprising extracting a gas sample from said headspace; analysing the gas sample for the presence of one or more target gases; and, upon detection of at least one of said one or more target gases, determining that said at least one fuse should not be replaced.

From a further aspect, the invention provides a device for extracting a gas sample from a valve or other outlet, the device comprising a housing defining at least one substantially fluid-tight chamber; a mouth portion for receiving at least part of said valve/outlet; and means for operating said valve/outlet.

In some embodiments, the housing provides a first chamber for receiving at least part of said valve/outlet, said substantially fluid-tight chamber being capable of fluid communication with said first chamber by means of at least one one-way valve arranged to allow fluid to pass from said first chamber into said substantially fluid-tight chamber.

Devices embodying any aspect of the invention may include a video camera substantially aligned with the direction in which said mouth portion faces.

Devices embodying any aspect of the invention may be mounted on, or removably mountable on, an elongate handle, e.g. a pole.

Preferred features are recited in the dependent claims.

Further advantageous aspects of the invention will be apparent to those ordinarily skilled in the art upon review of the following description of a specific embodiment and with reference to the accompanying drawing.

### BRIEF DESCRIPTION OF THE DRAWING

An embodiment of the invention is now described by way of example and with reference to the accompanying drawings in which like numerals are used to indicate like parts and in which:

FIG. 1 is a schematic view of a diagnostic device embodying one aspect of the invention;

FIG. 2 is a perspective view of an alternative embodiment of a diagnostic device, shown in a non-engaged state;

FIG. 3 is an alternative perspective view of the device of FIG. 2;

FIG. 4 is a side view of the device of FIG. 2

FIG. 5 is a rear end view of the device of FIG. 2;

FIG. 6 is a plan view of the device of FIG. 2;

FIG. 7 is a rear end view of the device of FIG. 2 with some of its component parts removed;

FIG. 8 is a perspective view of the device of FIG. 2 shown in an engaging state;

FIG. 9 is a side view of the device in the engaging state, with some of its component parts removed; and

FIG. 10 is a schematic diagram of the device of FIG. 2.

### DETAILED DESCRIPTION OF THE DRAWING

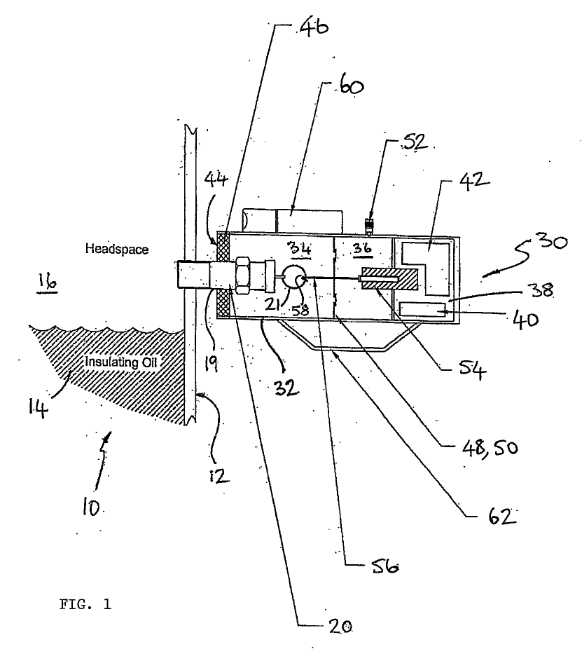

Referring now to FIG. 1, there is shown, generally indicated as 10, part of a piece of electrical apparatus that contains electrical insulating oil. In the present embodiment, the electrical apparatus is, by way of example, an electrical transformer of the type that is suitable for use in an electrical distribution system. Such transformers are typically located at ground level, or above ground level—for example mounted on an electricity pole.

The transformer 10 includes an enclosure 12, or tank, which contains the electrical windings (not shown) of the transformer. The windings are immersed in oil 14 to provide both electrical insulation and cooling. Normally, a headspace 16 is provided between the surface of the oil and the ceiling of the enclosure 12, typically above the oil. The headspace 16 usually contains air, but may include other gases as is explained in more detail below. A pressure relief valve (PRV) 20 (sometimes called a pressure relief device (PRD)) is normally provided in a wall of the enclosure 12 in the region of the headspace 16 in order to control the pressure in the enclosure 12 by allowing venting of gas to the surrounding environment.

The presence of particular substances in the insulating oil of transformers, and other electrical equipment, can provide an indication of the condition of the equipment. For example, the presence of acetylene (C₂H₂) in transformer oil is an indication of electrical breakdown (arcing). However, obtaining an oil sample can be problematic, especially when the transformer or other equipment is in service.

In arriving at the present invention, it has been found that an indication of the condition of electrical equipment, especially transformers, can be obtained by analysing the gas(es) present in the headspace above the insulating oil. In particular, it is found that the presence of acetylene in the headspace gas is indicative of a fault.

Referring again to the drawing, there is shown, generally indicated as 30, a diagnostic device, or apparatus, for use in the detection of faults in electrical equipment. In a simple form, the device 30 may be used to obtain a gas sample from the electrical equipment, although it may also include a gas analyser for analysing the gas sample. In preferred embodiments, the device 30 is adapted for obtaining a gas sample from the PRV 20, although in alternative embodiments, the device may be adapted to obtain gas samples from other valves or outlets.

The device 30 comprises a housing 32 which defines a first chamber 34 and, preferably, a second chamber 36 as well as, typically, a compartment 38 for an electrical power source, e.g. a battery 40, and any electronic circuitry 42 required by the device 30. The first chamber 34 includes a sealable mouth 44 through which the PRV 20, or other valve/outlet, may be inserted. The mouth 44 may include a self-sealing fluid-tight collar 46 arranged to provide a substantially fluid tight seal around the PRV 20 when inserted into the first chamber 34. The collar 46 may also close the mouth 44 in a substantially fluid-tight manner when the PRV 20 is not present. The first and second chambers 34, 36 are separated by a partition member, for example in the form of a membrane 48. One or more non-return valves 50 are provided between the first and second chambers 34, 36 to allow gas to pass from the first chamber 34 to the second chamber 36. The second chamber 36 is associated with an outlet 52 in the form of, for example, a syringe port.

The housing 32 further includes means for operating the PRV 20, or other valve or outlet. In the illustrated embodiment, the operating means comprises a linear actuator 54 which may for example comprise an electrical screw mechanism. The actuator 54 includes, or is coupled to, an actuating member in the form of a rod 56 for operating the PRV 20. The illustrated PRV 20 is a common type which includes a ring-pull device 21 which, when pulled in a direction away from the PRV 20, causes the PRV 20 to open. Hence, in the illustrated embodiment, the rod 56 includes a hook 58, or other means, for engaging with the ring pull 21. The linear actuator 54 is typically mounted substantially co-axially with the housing 32 and is arranged to actuate the rod 56 in a direction substantially along the longitudinal axis of the housing 32. The mouth 44 is arranged to receive the PRV 20 such that the ring-pull 21 is substantially aligned with said longitudinal axis so that linear movement of the rod 56, when engaged with the ring-pull 21, operates the ring-pull 21. The rod 56 may pass through the membrane 48, a substantially fluid-tight seal being provided between the rod 56 and the membrane 48.

A camera 60, e.g. a video camera, may be carried by the device 30, the camera 60 preferably being aligned to face in substantially the same direction as the mouth 44 so that the images generated by the camera 60 may be used to help guide the device 30 into engagement with the PRV 20. This is particularly useful in situations where the PRV 20 is difficult to reach, e.g. when the transformer is mounted on an electricity pole. In such cases, the device 30 may be mounted on an elongate member, e.g. a pole or other handle, in order to reach the PRV 20. The pole/handle may be at least 0.5 metres in length but more usually over 1 metre in length. To this end, the device 30 may include means for attaching, preferably releasably attaching, it to a pole or other elongate member. In the illustrated embodiment, the attachment means takes the form of a loop bracket 62, although it will be understood that any other suitable mechanism, e.g. clip, hook, buckle, screw/bolt attachment, may be used.

In the illustrated embodiment, the electronic circuitry 42 includes means for operating the linear actuator, means for operating the camera 60 and means for operating the collar 46 (which may for example be an inflatable type collar). In addition, to allow for cases where the device 30 has to be operated remotely, the circuitry 42 may include any suitable conventional, and typically wireless, communication circuitry to enable the device 30 to communicate with a remote control unit (not shown). The remote control unit may include switches and associated circuitry for operating the device 30, as applicable. The control unit may include a monitor for viewing the camera output, although the monitor may be provided separately.

In use, mounted on an elongate pole/handle if necessary, the device 30 is guided into engagement with the PRV 20 such that the PRV 20 is located in the first chamber 34 as shown in the drawing. If the collar 46 is of the type that requires positive operating, the device 30 is then operated to seal the collar 46 around the PRV 20. The actuator 54 is operated such that the rod 56, and more particularly the hook 58, engages with the ring-pull 21. The actuator 54 is further operated to open the PRV 20 thereby causing a quantity of gas to enter the first chamber 34 from the headspace 16. The gas then enters the second chamber 36 via the one way valves 50 and is provided therein. The actuator 54 is then operated to release the ring-pull 21 and, if required, the collar 46 is operated to release the PRV 20. The device 30 may then be removed from the PRV 20 with a gas sample contained with the chamber 36. The gas sample may then be removed for analysis. In the present embodiment, this is achieved by inserting a syringe (not shown) or other gas extraction device into the port 52.

The obtained gas sample may be provided to any suitable conventional gas analysing apparatus (not shown) for analysis. Should acetylene be detected in the gas sample, it may be deduced that the transformer has failed and that it is unsafe to replace fuse(s) associated with the transformer.

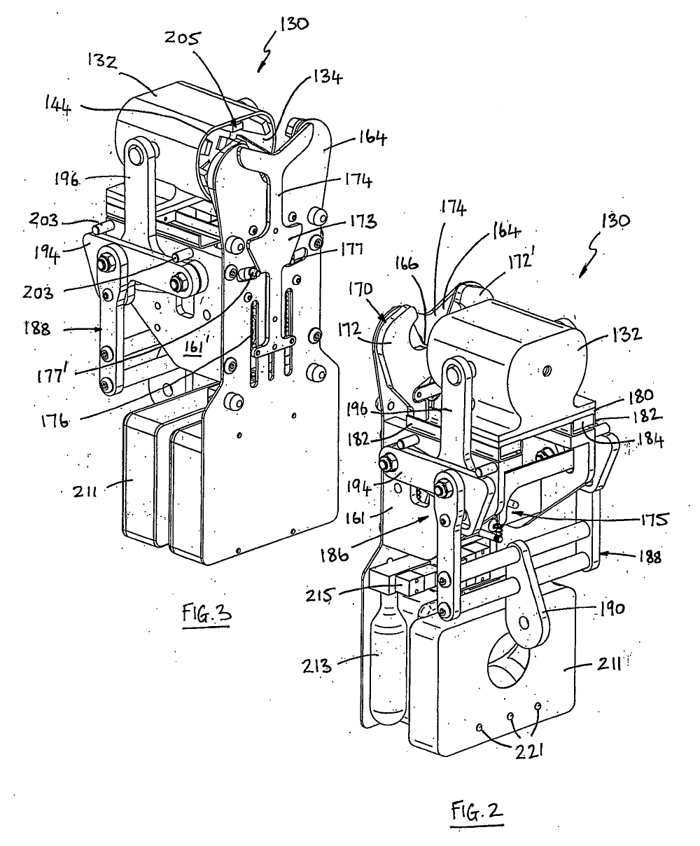

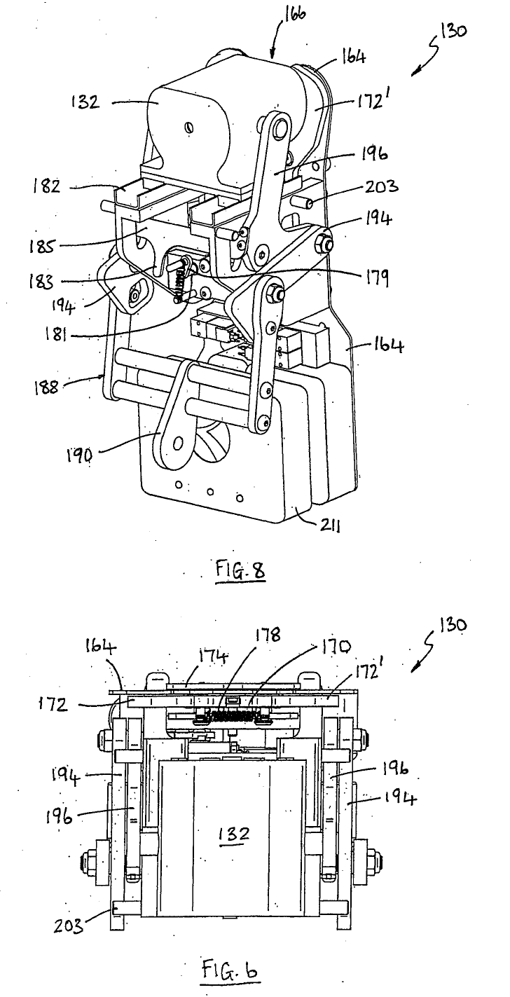

A preferred embodiment of the invention is now described by way of example and with reference to FIGS. 2 to 10, which show a diagnostic device 130, or apparatus, for use in the detection of faults in electrical equipment. The device 130 is capable not only of obtaining a gas sample, but also of analysing the gas sample. The device 130 includes means for locating the device 130 correctly with respect to the PRV 20. The locating means comprises a guide member 164, for example in the form of a plate, shaped to define a recess, or seat, 166 for receiving the PRV 20, typically a boss portion 19 of the PRV 20. A clamping device 170, which may be considered to comprise part of the locating means, is operable to clamp the PRV 20 when received in the recess 166. The clamping device 170 comprises first and second clamping jaws 172, 172′, one located on either side of the PRV 20 when present, operable into and out of a clamping state in which they grip the PRV 20. The clamping jaws 172, 172′ are conveniently pivotable into and out of the clamping state and may, for example, each be pivotably mounted to the guide 164.

An operating mechanism is provided for operating the clamping device 170 and may take any convenient form. In the illustrated embodiment, the operating mechanism includes an actuator 174 that is coupled to the jaws 172, 172′ such that movement of the actuator 174 from a non-activated state (shown in FIG. 2) into an activated state causes the clamping device 170 to be actuated into the clamping state. The actuator 174 overlaps with the recess 166 such that, as the PRV 20 is moved into the recess 166 (typically from above as viewed in FIG. 2), the PRV 20 moves the actuator 174 downwardly (as viewed in FIG. 2). When the PRV 20 is located in the crook of the recess 166, the movement of the actuator 174 is sufficient to cause the clamping device to adopt the clamping state. Referring to FIG. 3 in particular, the preferred actuator 174 includes a cam 173 with a respective cam surface. Each jaw 172, 172′ has a respective cam follower 177, 177′, conveniently in the form of pins, for engagement with a respective cam surface. One or more apertures may be provided in the plate 164 to this end. Downward movement of the actuator 174 causes the cam 173 to push the pins 177, 177′ apart and so to pivot the jaws 172, 172′ into the clamping state.

In the present embodiment, the actuator 174 is provided on the outside of the plate 164 and the clamping device 170 is provided on the inside of the plate 164. In alternative embodiments, these positions may be reversed, or both components 174, 164 could be provided on the same side of the plate 164.

Preferably, a latch mechanism 175 is coupled to the clamping device 170 to latch the clamping device in its clamping state. The latch mechanism 175 is preferably arranged to adopt its latching state when the clamping device 170 adopts the clamping state.

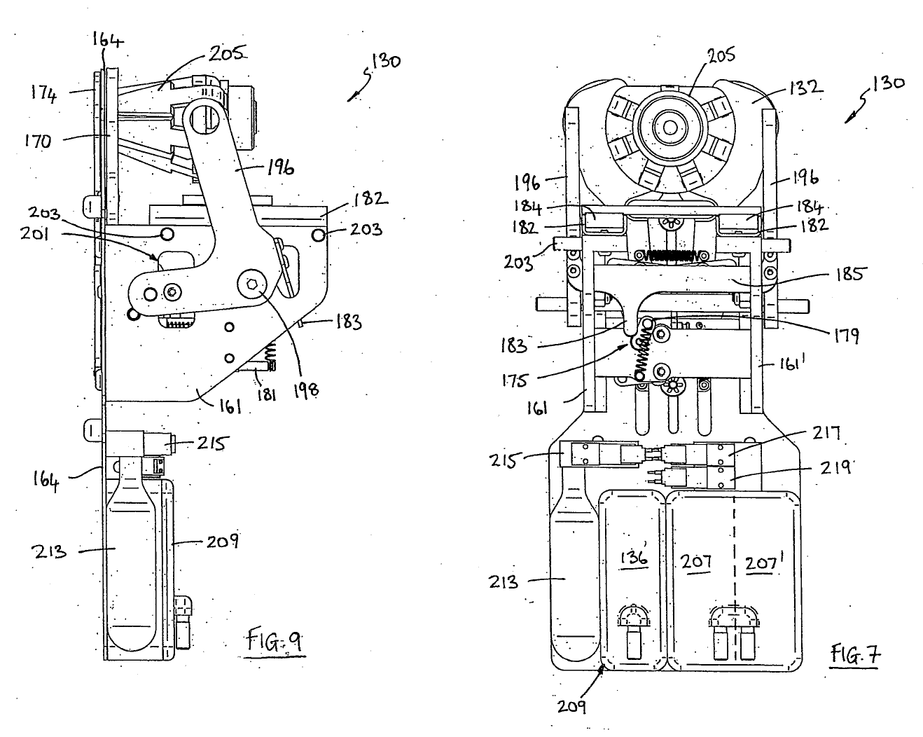

The actuator 174 may be resiliently biased to adopt its non-activated state by means of, for example, one or more springs 176. The clamping device 170 may be resiliently biased to adopt its non-clamping state (as shown in FIG. 2) by means of, for example, one or more springs 178. The preferred arrangement is such that, upon disengagement of the latch mechanism 175, the clamping device 170 adopts its non-clamping state. With reference to FIGS. 7 and 8, the preferred latch 175 includes a lever 179 connected to a shaft 181, the shaft being pivotable about its longitudinal axis. Hence the lever 179 is able to move, or pivot, left and right as viewed in FIG. 7. The lever 179 adopts a first position, as shown in FIG. 7, when the clamping jaws 172, 172′ are open. When the clamping jaws 172, 172′ are closed and latched, the lever 179 adopts a second position, in which it is pivoted in an anticlockwise direction as viewed in FIG. 7, in which it is in register with a portion 183 of a latch release mechanism 185. The latch release mechanism is coupled to an actuating mechanism for a housing 132 which is described in more detail hereinafter. The shaft 181 is also movable in its axial direction and is coupled to the cam followers 177, 177′ such that axial movement of the shaft 181 causes the cam followers 177, 177′ to be withdrawn from the cam 173 to allow the clamping device 170 to open. In use, the shaft 181 is acted upon by the portion 183 to release the latch 175, as is described in more detail hereinafter.

It will be apparent from the foregoing that relative movement (which in typical use involves an upwards movement of the device 130) between the device 130 and the PRV 20 causes the clamping device 170 to clamp the PRV 20.

The device 130 further includes a housing 132 that defines, or includes, a first chamber 134 for receiving a gas sample. The housing 132 is movable towards and away from the clamping device 170. The movement of the housing 132 is preferably substantially linear and, typically, substantially perpendicular with the plane in which the recess 166 lies. As a result, when the PRV 20 is located in the recess 166 (as shown in FIG. 5), the housing 132 may be moved towards and away from the PRV 20, conveniently in a direction that is substantially parallel with the longitudinal axis of the PRV 20. In typical use, the movement of the housing 132 is substantially horizontal. To this end, the housing 132 is mounted on a carriage 180, the carriage 180 being coupled to the device 130 by means of one or more guides 182 along which the carriage 180 may be moved. For example, the guides 182 may take the form of track(s) to which the carriage 180 is slidably coupled by corresponding runner(s) 184 or rollers (not illustrated).

Means for actuating the housing 132 are also provided. The actuating means preferably comprises a mechanical linkage mechanism 186 coupled to the housing 132 and having an operating member 188. Advantageously, the operating member 188 is connected to, or removably connectable to, a pole (not shown) or other elongate handle, by means of, for example, connector 190. The linkage mechanism 186 is arranged to translate movement of the operating member 188 in an, in use, generally downwards direction into a corresponding movement of the housing 132 towards the clamping device 170, and an, in use, generally upward movement of the operating member 188 into a corresponding movement of the housing 132 away from the clamping device 170. In alternative embodiments (not illustrated) the linkage mechanism may be arranged to effect the reverse translation of movement of the operating member.

In the illustrated embodiment, the linkage mechanism 186 comprises two sets of linkage members 194, 196, a respective set on either side of the housing 132. It will be apparent that more or fewer sets of linkage members may be used in alternative embodiments. The first linkage member 194 is coupled to and extends between the operating member 188 and the second linkage member 196. The coupling between the link 194 and the operating member 188 is preferably pivotable and, preferably still, a pin and slot mechanism (or other movement restricting mechanism) is provided between the link 194 and the operating member 188 to restrict the amount of relative pivoting movement between the two. The coupling between the first link 194 and the second link 196 is also pivotable. The second link 196 extends between, and is coupled to, the first link 194 and the housing 132. The second link 196 takes the form of a crank, i.e. is bent, and is pivotably coupled to the device 132 at its crook 198.

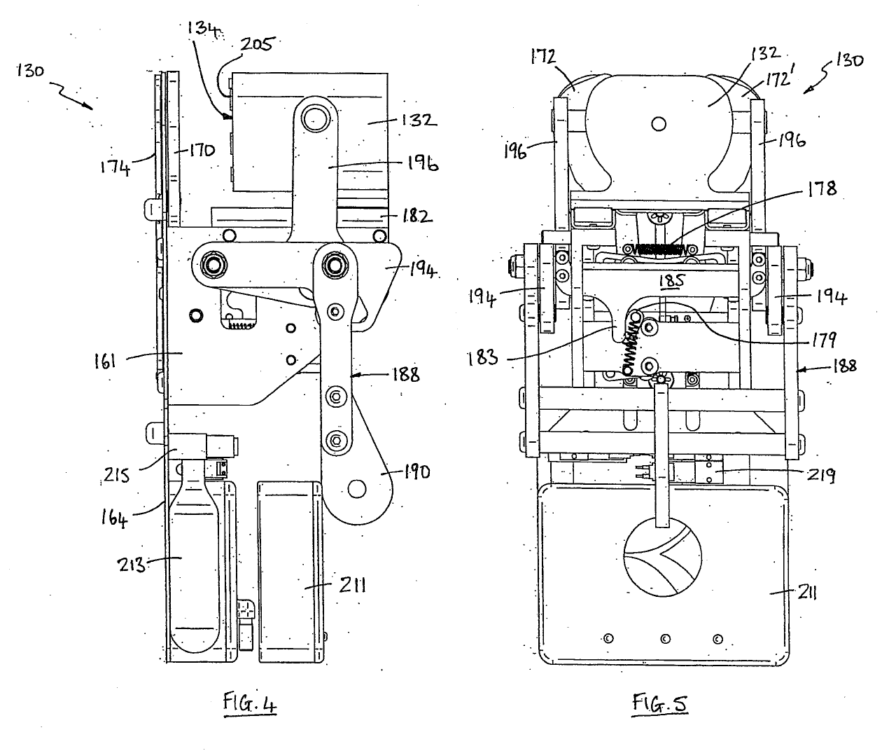

In use, downward movement of the operating member 188 causes downward movement of the first link 194 which in turn causes the second link 196 to pivot about its crook 198 (anticlockwise as viewed in FIGS. 2 and 4) and so to move the housing 132 towards the clamping device 170 (see FIG. 8). Upward movement of the operating member 188 lifts the first link 194 which in turn causes the second link 196 to pivot about its crook 198 (clockwise as viewed in FIGS. 2 and 4) and so to move the housing 132 away from the clamping device 170.

Preferably, one or both of the links 194, 196 are coupled to the body, or frame, of the device 130 by a pin and slot mechanism 201 (or other movement restricting mechanism) to limit the extent of movement of the links 194, 196 with respect to the device 130. One or more stop members 203 may be provided for this purpose also. The coupling between the second link 196 and the housing 132 preferably takes the form of a pin and slot mechanism. The linkage mechanisms on each side of the housing 132 are conveniently substantially the same. It will be seen that in this embodiment, the body, or frame, of the device 130 is provided by a back plate 164 and two spaced apart supports 161, 161′ projecting from the plate 164.

It will be understood that, in alternative embodiments, other mechanical or electro-mechanical means (not illustrated) may be provided to move the housing 132.

The housing 132 has a mouth 144, which may for example be similar to the mouth 44 of FIG. 1, for receiving the PRV 20 such that the outlet of the PRV 20 is inside the first chamber 134. In the preferred embodiment, the mouth 144 is adapted to seal against the clamping device 170 (or other part of the device 132 which may in alternative embodiments be locatable around the PRV 20). To this end, a ring of deformable material (not shown), e.g. foam, plastics, rubber, or inflatable, is provided around the mouth 144. The arrangement is such that, when the housing 132 is in sealing engagement with the clamping device 170, the outlet of the PRV 20 is located inside the first chamber 134. Preferably, the mechanical linkage mechanism 186 includes, or is co-operable with, a latching mechanism (not shown) for latching the housing 132 in position against the clamping device 170. The latching mechanism may for example comprise a ratchet and pawl device (not visible) coupled to the links 196 and arranged to engage to prevent movement of the links 196 in an anticlockwise direction as viewed in FIG. 8 once the link 196 have reached a position in which the housing 132 engages with the clamping device 170. The latching mechanism is preferably coupled to the operating mechanism 188, directly or indirectly, so that, with the device 130 in the latched state shown in FIG. 8, general upwards movement of the operating mechanism 188 causes the latching mechanism to release to allow the housing 132 to move away from the clamping device 170.

A gripping device 205 is located inside the housing 132, typically inside the chamber 134. The gripper 205 may take any suitable form, for example a multi-fingered mechanical gripper. The gripper 205 is operable to grip the PRV 20 when inside the housing 132. In particular, the gripper 205 is arranged to grip the operating mechanism of the PRV 20. In the illustrated embodiment, the gripper 205 is movable with respect to the housing 132 in a direction axial of the housing 132, i.e. towards and away from the clamping device 170, and therefore the PRV 20 when present. Any conventional linear actuating mechanism (not shown) may be provided for this purpose. The gripper 205 is operable to move away from the PRV 20 when gripping its operating mechanism and so to open the PRV 20 to the chamber 134. This arrangement assumes that the PRV 20 is of the type shown in FIG. 1 that is operable by a pulling action. Other gripping or PRV operating means may be provided to cope with other types of PRV. In the illustrated embodiment, the gripper 205 is pneumatically operated and, to this end, a source of pressurised gas, typically air, is provided in the convenient form of a canister 213. The canister 213 is connected to the gripper to supply compressed air thereto under the control of a valve 215, e.g. a solenoid valve. Conveniently, the mechanism for actuating the gripper 205 back and forth is also pneumatically operated. In alternative embodiments, the gripper and its actuator may be operated by any other suitable means, e.g. hydraulic or electric.

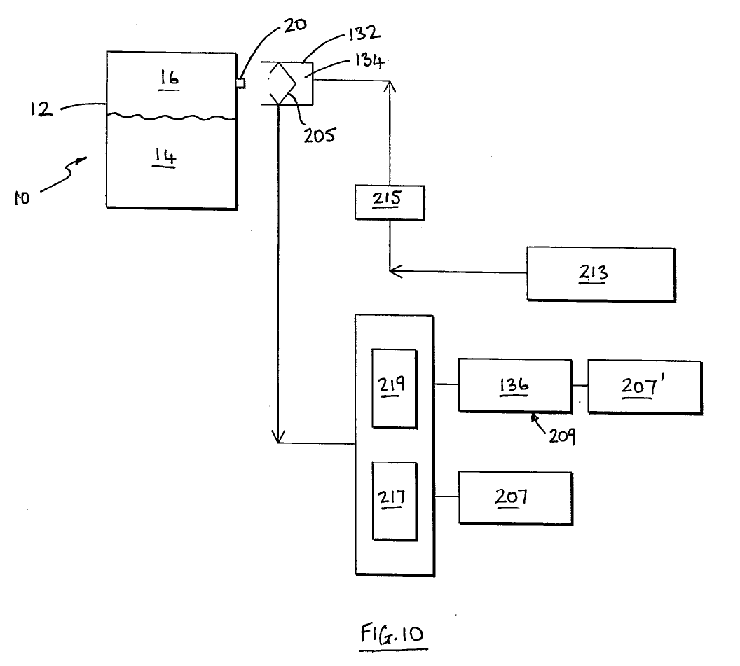

Reference is now made in particular to FIG. 7 and FIG. 10. The device 130 preferably includes a second chamber 136 for receiving a gas sample. The device 130 further includes means for creating a partial vacuum in the first chamber 134 and preferably also the second chamber 136. The device 130 preferably also includes means for evacuating gas from the first chamber 134 to the second chamber 136. To this end, first and second vacuum chambers 207, 207′ are provided (shown contained in a single unit), each chamber 207, 207′ being held, at least in an initial state, in partial vacuum. The first vacuum chamber 207 is in selective fluid communication with the first chamber 134 under the control of a second valve 217, e.g. a solenoid valve. The valve 217 is operable to cause the vacuum chamber 207 to create a partial vacuum in the first chamber 134. The first vacuum chamber 207 may optionally also be in selective fluid communication with the second chamber 136 under the control of a valve, e.g. the valve 217, so that the second chamber 136 may also be partially evacuated. The second chamber 136 may alternatively be connectable to its own respective vacuum chamber for this purpose.

The second vacuum chamber 207′ is in selective fluid communication with the second chamber 136 and the first chamber 134 under the control of a third valve 219, e.g. a solenoid valve. The valve 219 is operable to cause the vacuum chamber 207′ to draw gas from the first chamber 134 into the second chamber 136.

Advantageously, the device 130 includes a pressure sensor (not shown) for sensing the pressure of the gas contained in the first chamber 134. The pressure sensor is conveniently located within the chamber 134. Preferably, a pressure sensor (not shown) is provided for sensing the pressure of the gas in the second chamber 136, and may conveniently be located in the second chamber 136.

In the preferred embodiment, the device 130 further includes a gas analyser 209 for analysing the gas extracted from the headspace 16. Conveniently, the analyser 209 is arranged to analyse the gas contained in the second chamber 136 and is thus connected to, or connectable to, the second chamber in any suitable conventional manner. In the illustrated embodiment, the second chamber 136 forms part of the gas analyser. In particular, the analyser 209 is adapted to detect the presence of acetylene in the gas sample, although it may alternatively or in addition be adapted to detect the presence of one or more other gases that are indicative of faults in electrical equipment and which may be found in the headspace gas. By way of example, a gas analyser of the type produced by Kelman Limited of Lissue Industrial Estate, Lisburn, United Kingdom is suitable for use as the analyser 209. The analyser 209 may alternatively, or in addition, be arranged to analyse gas in the first chamber 134 (in which case the second chamber 136 may be omitted). In alternative embodiments, the analyser is separate to the device, the device being adapted for connection to the analyser after a gas sample has been obtained.

The device 130 further includes an electrical control unit 211 for controlling the operation of the device 130. The control unit 211 may include, or be connected to, an electrical power source (not shown), such as one or more batteries. The controller 211 may use any suitable conventional means, e.g. microcontroller, PLC and/or dedicated circuitry (not shown) for controlling the device 130, and in particular for controlling the operation of the valves 215, 217, 219, and the analyser 209. The control unit 211 may be arranged to provide signals to a user indicating the status of the device 130, e.g. operating, finished, fault gas detected and/or no fault gas detected. The signals may take the form of illuminating one or more lamps 221, e.g. LEDs. Alternatively, or in addition, the device 130 may be adapted to communicate wirelessly with a remote unit (not shown). In a typical mode of use, a user (not shown) positions the device 130 against the side of the tank 12 beneath the PRV 20. In most instances, the tank 12 is located off the ground and so it is necessary to mount the device on a pole or other elongate handle. The device 130 is pushed upwards until the actuator 174 engages with the PRV 20. Further upward movement of the device 130 causes the actuator 174 to be pushed downwardly by the PRV 20 and so causes the clamp 170 to clamp the PRV 20, and activates the latch 175 to latch the clamp 170 in its closed state. Hence, the device 130 is secured to the PRV 20. The user then pulls down on the operating member 188, in this example using the pole, thereby causing the housing 132 to move into sealing engagement with the clamp 170, and causing the actuating mechanism 186 to be latched in this position. In this state, the PRV 20 is located inside the chamber 134, the chamber 134 being substantially fluid-tight by means of the seal between the mouth 144 and the clamping device 170. Optionally, an electrical switch or sensor (not shown) is provided to detect the engagement of the housing 132 with the clamp 170 and to signal this event to the control unit 211.

In response, the control unit 211 operates valve 217 to evacuate the first chamber 134, and in the preferred embodiment also the second chamber 136, to create a partial vacuum therein. Valve 217 may then be closed. The pressure sensor detects the reduced pressure in the chamber 134 and signals this event to the control unit 211. In response, the control unit 211 causes the gripper 205 to grip the PRV 20 and to retract the gripper 205 by, in this example, operating valve 215. This causes the PRV 20 to open and, assisted by the partial vacuum in the chamber 134, a sample of headspace gas 16 is drawn out of the tank 12 into the chamber 134. The pressure sensor detects the change in pressure in the chamber 134 and signals this event to the control unit 211. In response, the control unit 211 causes the gas sample to be drawn into the second chamber 136 for analysis by the analyser 209. This is achieved by operating valve 219, which may be closed after the sample has been drawn into the chamber 136. Transfer of the gas sample from the first chamber 134 to the second chamber 136 may be detected by the pressure sensor in the first chamber 136 or by a pressure sensor in the second chamber 136. In either case, the event is signalled to the control unit 211 which then causes the sample to be analysed by the analyser 209. The analyser 209 communicates the results of the test to the control unit 211 (which may be a simple pass or fail signal) which in turn communicates the result to the user.

When the test is completed, the control unit 211 causes the gripper 205 to move forward and to release the PRV 20, thereby causing the PRV 20 to close. The user then moves the operating member 188 upwardly, causing the latch which holds the actuating mechanism 186 to release. Further upward movement of the operating member 188 causes the housing 132 to move away from the clamp 170. During this movement, the latch release mechanism 185, which in this example comprises a bar connected between the links 196, acts on the lever 179 of the latch mechanism 175 to push the shaft 181 in a right to left direction (as viewed in FIG. 9). This causes the cam followers 177, 177′ to be retracted which in turn releases the clamping mechanism and allows it to release the PRV 20 under the action of the spring 178. The device 130 can then be withdrawn from the PRV 20 and the actuating member 174 returns to its initial position under the action of the springs 176.

The invention is not limited to use with electrical transformers and may alternatively be used with any electrical equipment containing electrical insulating oil. In particular the equipment may have one or more of its electrical components wholly or partially immersed in the oil. The invention is particularly suited for use with equipment having a pressure relief valve/device to allow venting of a headspace region above the insulating oil, and especially where the pressure relief valve/device is located at the in use side of the equipment. The invention is particularly useful in cases where the electrical equipment, especially electrical transformers, is located, in use, in an elevated position, e.g. mounted on an electricity pole. The invention allows the equipment to be tested for the occurrence of a fault without having to remove it from the pole, and so to determine whether or not a blown fuse can be safely replaced.

In alternative applications, the device 30, 130 may be adapted to extract gas samples from valves other than pressure relief valves.

The invention is not limited to the embodiments described herein which may be modified or varied without departing from the scope of the invention.

1. A diagnostic device for use in the detection of a fault in an electrical apparatus comprising an enclosure containing at least one electrical component immersed in electrical insulating oil, the oil partly filling the enclosure to define a headspace adjacent the oil, and wherein a pressure relief valve is provided in the enclosure to vent excess fluid pressure in the headspace, the device comprising:
a housing defining a first chamber, the first chamber having a mouth adapted to receive said pressure relief valve;
sealing means for creating a substantially fluid tight seal around said pressure relief valve; and
operating means for operating the pressure relief valve to extract a gas sample from said headspace into said first chamber.

2. A device as claimed in claim 1, further including a gas analyzer for analyzing said gas sample to detect the presence of one or more target gases.

3. A device as claimed in claim 1, further including indicating means for indicating a fault in said electrical application upon detection of at least one of said one or more gases.

4. A device as claimed in claim 1, wherein said operating means includes means for engaging said pressure relief valve, said engaging means being retractable by a linear actuating mechanism and, preferably, being located in said first chamber.

5. A device as claimed in claim 1, wherein the device is mounted on an elongate handle.

6. A device as claimed in claim 1, further including first vacuum means for creating a partial vacuum in said first chamber.

7. A device as claimed in claim 1, further including a second chamber being in selective fluid communication with said first chamber and valve means for causing said gas sample to be transferred from said first chamber to said second chamber.

8. A device as claimed in claim 7, further including a gas analyzer for analyzing said gas sample to detect the presence of one or more target gases and wherein said second chamber is part of, or connected to, said gas analyzer, the gas analyzer being arranged to analyze said gas sample when in said second chamber.

9. A device as claimed in claim 1, further including locating means shaped to define a seat for said pressure relief valve, wherein said housing is movable towards and away from said locating means into and out of a use state in which the pressure relief valve, when seated in said seat, is located in said first chamber.

10. A device as claimed in claim 9, wherein, in said use state, said housing engages with said locating means, and wherein said sealing means creates a substantially fluid tight seal between said housing and said locating means.

11. A device as claimed in claim 9, wherein said locating means includes a clamping device operable to releasably clamp said pressure relief valve when seated in said seat.

12. A device as claimed in claim 11, wherein said locating means further includes an actuator for operating said clamping device, the actuator being movable with respect to the seat into and out of a primed state in which a portion of the actuator overlaps with said seat, and being coupled to the clamping device such that movement of the actuator out of the primed state causes the clamping device to close.

13. A device as claimed in claim 9, further comprising a mechanical linkage mechanism and an operating member, the linkage mechanism coupling the operating mechanism to said housing and being arranged to effect movement of said housing into and out of said use state.

14. A device as claimed in claim 13, wherein the linkage mechanism is arranged to translate generally upwards and generally downwards movement of said operating member into reciprocating movement of said housing.

15. A device as claimed in claim 14, wherein the linkage mechanism is arranged to translate movement of the operating member in a generally downwards direction into a corresponding movement of the housing into the use state, and a generally upward movement of the operating member into a corresponding movement of the housing out of the use state.

16. A device as claimed in claim 13, wherein the operating member is connected to, or removably connectable to, an elongate handle.

17. A device as claimed in claim 1, wherein said operating means comprises a gripping device located within said first chamber and being operable to grip said pressure relief valve.

18. A device as claimed in claim 17, wherein said gripping device is movable within the housing in a direction that is axial of the housing.

19. A method for detecting a fault in an electrical apparatus comprising an enclosure containing at least one electrical component immersed in electrical insulating oil, the oil partly filling the enclosure to define a headspace adjacent the oil, and wherein a pressure relief valve is provided in the enclosure to vent excess fluid pressure in the headspace, the method comprising:
operating the pressure relief valve to extract a gas sample from said headspace;
analyzing the gas sample for the presence of one or more target gases; and
upon detection of at least one of said one or more target gases, determining that there is a fault in the electrical apparatus.

20. A method as claimed in claim 19, wherein said analysis involves detecting the presence of acetylene (C₂H₂) in the gas sample.

21. A device as claimed in claim 1, wherein said electrical apparatus comprises an electrical transformer.

22. A device as claimed in claim 2, wherein said gas analyzer is adapted to detect the presence of acetylene (C₂H₂).

23. A device as claimed in claim 8, wherein said gas analyzer is adapted to detect the presence of acetylene (C₂H₂).
